(19) United States
(12) Patent Application Publication
(10) Pub. No.: US 2023/0106751 A1
(43) Pub. Date: Apr. 6, 2023

(54) COMPUTER-IMPLEMENTED METHODS AND SYSTEMS FOR PROPOSAL AND DONATION OF AN OBJECT

(71) Applicant: Exchange Technologies International, Inc., New York, NY (US)

(72) Inventors: Robert Wainstein, Toronto (CA); David Moos, Toronto (CA); Donald Steinert, New York, NY (US); Sarah Harper Ross, Greenport, NY (US); Matthew Doumar, Asheville, NC (US)

(21) Appl. No.: 17/951,384

(22) Filed: Sep. 23, 2022

Related U.S. Application Data
(60) Provisional application No. 63/252,492, filed on Oct. 5, 2021.

(51) Int. Cl. G06Q 30/06; G06Q 30/02; G06Q 30/00; G06Q 10/08

(52) U.S. Cl. CPC G06Q 30/0609; G06Q 30/0603; G06Q 30/0627; G06Q 30/0205; G06Q 30/0185; G06Q 10/087

(57) ABSTRACT

Systems and methods for facilitating proposals and donations of objects is provided. The method includes transmitting object information from a donor device to be presented in a catalogue of a objects offered for donation and shared with a plurality of prospective donees. Thereafter, receiving a plurality of proposals for acquisition of the object from the plurality of prospective donees, wherein the system is configured to concurrently transmit all of the plurality of proposals to the donor device. The donor using the donor device selects a proposal from the plurality of proposals based on the preference of the donor. The object information may include a plurality of terms and conditions, wherein the terms and conditions are stipulations for a prospective donee in order to acquire the donated object. Advantageously, donations services including loan agreement, shipping arrangements, appraisal may be efficiently formalized using the systems and methods.

### TECHNICAL FIELD

The following generally relates to donation of objects, and more particularly to a system and method for facilitating proposals and donations of art works.

### INTRODUCTION

Objects of donation may include art works such as paintings, drawings, canvas, composition, murals, posters, portraits, cartographic works such as maps, globes, cartoons, collages, enamel works, digital art such as hologram, laser artworks, photographs, jewelry and apparel design, models, mosaics, needlework and handicraft, engravings, etchings, knitting, sewing patterns, crochet, photomontages, reproductions, sculpture such as carvings, ceramics, figurines, maquettes, glass design, stencils, or any other form of visual or acoustic art works. Paintings further include oil painting, watercolor painting, pastel painting, acrylic painting, digital painting, spray painting, hot wax painting, encaustic painting and enamel painting.

Art collectors may include a private individual or a public or private institution. Art collectors accumulate a wide range of art works and are known to donate or bequeath their art collections, or several works from their collection, to donees of choice. Art collectors may not have the time or resources to manage a large art collection. The art collectors may prefer their art collection being appreciated by a larger audience. Further, the art collectors may downsize their art collection for management of their estate. However, an art collector who wishes to donate a piece of art may have certain terms and conditions for the donee of the artwork. The conditions may include the manner in which the artwork is displayed, no-further donation or sale of artwork, no modification or artwork, and safe transport/storage and maintenance of the artwork.

Museums or other organizations are common destinations for art works donated by the art collectors. Other organizations may include non-profitable or tax-exempt organizations such as educational, scientific, literary, animal welfare organizations (e.g., 501(c)(3) designated organizations). Museums offer the opportunity of storing, maintaining, and curating the art works safely. Further, museums may display any artwork to the public and provide access for civic engagement, public awareness, and cultivate a culture of creativity and art discourse. Art collectors may be motivated to donate the artwork to a specific museum to promote public attention to the museum and help local businesses. The artwork may also be donated to a museum located in an area that shares history with the artwork or the creator of the artwork. Further, the museums may display the artwork on loan from an institution or an organization without having ownership to that artwork.

However, the existing process for donation of objects, specifically art works remains highly cumbersome and inefficient. Donors have a limited reach and are not aware of the organizations accepting donation. The donation process involves a plurality of steps including compiling the ownership documents, provenance documents, artist name, performing proposals, preparing terms and conditions for the donation. Further, donation of art works to a museum or a public institution may be eligible for tax deduction amounting to the artwork's market value. Preparing the tax write off documents and ensuring the donee organization is a qualified recipient under the income tax laws for tax credits form an important part of the tax donation process. Further, the art donor may prefer reviewing a catalogue of current collection of the museum before deciding the donation process. The art donor may require the artwork be displayed at a specific location in the museum and include the name of art donor to be displayed along the artwork.

Further, the donee organizations may have their own criterion such as only accepting unconditional donations. In event of the donation of a large size or when a donated artwork includes multiple pieces, the donee museum may disassemble or divide the artwork while being put on display.

Additionally, the donation process may include appraisal of the object before executing the Deed of Gift. The other formal requirements in the donation process may include compliance with legal requirements from regulatory or taxation authorities. This may include a formal appraisal of the object and completing the Form 8283 as required by the Internal Revenue Service. Conventionally, meeting the formal requirements in the donation process includes recurrent communication between multiple parties, receiving signatures and sharing documents. In absence of a platform technologically configured to the needs of the donation process may lead to delays and inefficiencies in the donation process.

Conventionally, object donation, in particular artwork donation systems and processes are entirely manual leading to inefficiency in the donation process and causing significant delay. The art collector may be required to individually contact the museums informing them of the prospective donation and the artwork. The art collector may be limited to a few museums in the search process. The museums may thereafter prepare proposals indicating their interest in the artwork. The art collector may be required to individually review the proposals every time a proposal is received. The sequential receipt of proposals may preclude the art collector from reviewing all the proposals at the same time and choosing one based on the time it is received rather than on merit. Further, with the manual involvement of third parties such as art appraiser, tax credit assessor, and shipping services may add to the inefficiency and delay in the art donation process. Further, conventional donation systems may not be configured to provide services for donation of digital art, especially non-fungible tokens.

Accordingly, there is a need for systems and methods for object donations, and more particularly to a system and method for facilitating proposals and donations of art works.

### SUMMARY

A computer-implemented method for proposal and a donation of an object is provided. The method includes receiving object information entered on a donor device, wherein the object information describes the object offered for donation; receiving validation of the object information from an administrator device; adding at least a subset of the object information to a catalogue, wherein the catalogue lists objects offered for donation; transmitting the catalogue for display on a plurality of donee devices; receiving one or more proposals to acquire the object from one or more donee devices; receiving validation of the one or more proposals from an administrator device; transmitting the stored proposals to the donor device at the end of the submission period; and receiving a selection of one proposal from the donor device.

The object information may include a plurality of terms and conditions for a prospective donee to receive the object offered for donation.

The object information may include any one or more of: a plurality of photograph of the object, a type of the object, a subject matter of the object, a condition of the object, an acquisition detail of the object, a description of the object, a location of the object, a name of an artist who created the object, a historical background of the object, a date of creation of the object, a provenance related to the object, a dimension of the object, a type of material used in the object, a plurality of identification information of the donor, an ownership tie of the donor to the object, a third party authentication of the object, and a list of previous owners of the object.

The plurality of terms and conditions may include any one or more of: a placement condition for the donee museum, a restriction on further sale of the object, a restriction on further donation of the object, a restriction on modifying or disassembling the object, a preference to donees from a geographical location, and a plurality of rights to the object that the donor may not prefer to transfer to the prospective donee.

The method may further include validating the object information by including verifying authenticity of the object; verifying chain of title to the object; and verifying the object information.

The method may further include validating the object information by including transmitting a request for additional object information to the donor device; and receiving additional object information from the donor device.

The subset of object information added to the catalogue may include a photograph of the object, the subject matter of the object, the description of the object, the location of the object, and the name of an artist who created the object.

The method may further include omitting the plurality of identification information of the donor from the subset of object information.

The method may further include: each proposal including at least a name of a prospective donee, contact information of the prospective donee, the location of the prospective donee, a letter of interest, a plurality of contextual images, and shipping information.

The method may further include: each proposal further includes a response by the prospective donee to the plurality of terms and conditions

The letter of interest may include any one or more of: details of the prospective donee, an inventory of the prospective donee, a plurality of artifacts displayed by the prospective donee, an information on appropriateness of the object in the inventory of the prospective donee, an exhibition program of the prospective donee, a historical background of the prospective donee, a plurality of collections by the artist who created the object in the inventory of the prospective donee, an account of general audience of the prospective donee, a donation policy of the prospective donee, a curatorial practice of the prospective donee, and a standard operating procedure for maintenance followed by the prospective donee.

The plurality of contextual images by the prospective donee may include a floor plan of a donee museum, an arrangement of artworks displayed in the donee museum, a plurality of photographs of related artworks in the collection of the donee museum, a description of each contextual image, and a potential location to display the object.

The method may further include: transmitting the stored proposals to the donor device instantaneously on receiving validation from the administrator device.

A method for accessioning an object after selecting a proposal is provided. The method includes submitting a donation form from a donor terminal over a donation management computer system for donating an object to a selected donee; notifying the selected donee on being selected as a recipient of the object set for donation and transmit a donation form information to a donee terminal; and confirming an acceptance from the donee terminal on being selected as the recipient of the object set for donation, wherein the confirmation is based on the review of the donation form information.

The donation form may include information on the ownership of a donor on the object set for donation, identification information of a representative of the donor, identification information on the donor, a mailing address of the donor, and a credit line of the donor.

The confirmation of the acceptance from the donee terminal may include assigning a registrar as a designated representative to respond to a plurality of formal requirements, provide documentation and a signature for the accessioning of the object.

The plurality of formal requirements may include a method for concluding a Deed of Gift between the donor and the selected donee. The method for concluding a Deed of Gift between the donor and the selected donee includes transmitting the Deed of Gift from the donee terminal over a donation management computer system, wherein the transmission includes assigning a representative of the selected donee to countersign the Deed of Gift; reviewing of the Deed of Gift by the donor terminal; providing an electronic signature to the Deed of Gift at the donor terminal, wherein the Deed of Gift includes a credit line of the donor; providing an electronic counter-signature to the Deed of Gift at the donee terminal, wherein the representative of the selected donee is notified by the donation management computer system when the electronic signature to the Deed of Gift at the donor terminal is executed; and wherein the Deed of Gift transfers a title and an ownership of the object from the donor to the selected donee.

### BRIEF DESCRIPTION OF THE DRAWINGS

The drawings included herewith are for illustrating various examples of articles, methods, and apparatuses of the present specification.

FIG. 1 is a schematic diagram of a system for facilitating proposal and donation of an object, according to an embodiment;

FIG. 2 is a block diagram of a computing device of FIG. 1, according to an embodiment;

FIG. 3 is a block diagram of a backend server for hosting a platform for facilitating proposal and donation of artwork, according to an embodiment;

FIG. 4 is a flow diagram of a method 400 for submitting an object for donation, review and display of the object on a catalogue, submitting a proposal to receive the object, and selecting the proposal to donate the object, according to an embodiment;

FIG. 5 is a flow diagram of a method 500 for accessioning the object after selecting a proposal, according to an embodiment;

FIG. 6 is a flow diagram of a method 600 for completing the donation after confirming the donor's acceptance to the donation, according to an embodiment;

FIG. 7 is a flow diagram of a method 700 for providing shipping arrangements for the object set for donation, according to an embodiment;

FIG. 8 is a flow diagram of a method 800 for conducting an appraisal of the object set for donation, according to an embodiment;

FIG. 9 is an exemplary screen capture of a donor dashboard view showing active donation processes for a plurality of objects set for donation, according to an embodiment;

FIG. 10 is an exemplary screen capture of a donor dashboard view showing summarized object information, according to an embodiment;

FIG. 11 is an exemplary screen capture of a proposal for submitting an expression of interest in acquiring an object listed for donation, according to an embodiment;

FIG. 12 is an exemplary screen capture of a task manager for coordinating and performing the tasks in the donation process, according to an embodiment; and

FIG. 13 is an exemplary screen capture of a donation overview displaying completed status of all the tasks in the donation process, according to an embodiment.

### DETAILED DESCRIPTION

The systems and methods described herein generally relate to donations of objects, and more particularly to system and method for facilitating proposals and donations of art works.

References herein to ‘object’ or ‘artwork’ means a visual or acoustic work not limited to, paintings (e.g., oil painting, watercolor painting, pastel painting, acrylic painting, digital painting, non-fungible tokens (NFTs), spray painting, hot wax painting, encaustic painting and enamel painting), drawings, canvas, composition, murals, posters, portraits, cartographic works such as maps, globes, cartoons, collages, enamel works, digital art such as hologram, laser artworks, photographs, jewelry and apparel design, models, mosaics, needlework and handicraft, engravings, etchings, knitting, sewing patterns, crochet, photomontages, reproductions, sculpture such as carvings, ceramics, figurines, maquettes, glass design and stencils.

References herein to a ‘donor’ means an entity or an individual that offers or donates an object in ownership or possession of the donor, to a donee, with or without any terms and conditions. A donor may be an art collector, an estate, an executor of an estate, a private individual or organization, or a public institution or organization.

References herein to a ‘donee’ or a ‘donee beneficiary’ or a ‘donee museum’ means an entity or representatives of an entity or an individual that proposes or receives, accepts the object of donation from the donor, with or without any terms and conditions. A donee may be a private individual or organization, a public institution or organization, a charitable organization, a museum, an art gallery, an archive, or a library.

References herein to ‘accessioning’ mean the formal process of accepting an object into a museum collection.

References herein to signing and countersigning include providing digital signatures to documents for meeting formal requirements of the donation process.

In the field of art donation, it is advantageous to create a digital marketplace and a platform to facilitate the donation and curatorial process.

The systems and methods in the present disclosure include providing a platform where donors may submit their objects for donation and donees, such as a museum, may review the catalogue of the objects set for donation and select an object of interest based on the donee's preferences. The donee may thereafter submit a proposal including details of the donee, curatorial requirements, and responding to any queries or terms and conditions put forward by the donor.

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, and tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

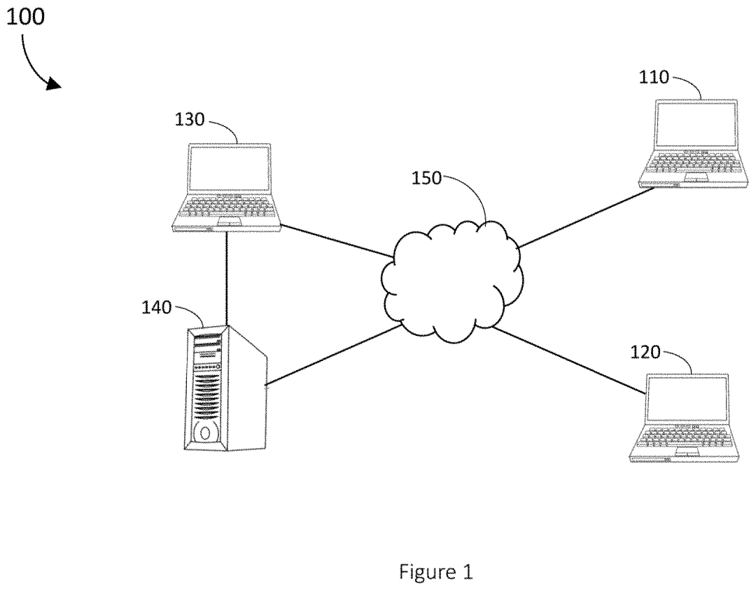

Referring to FIG. 1, illustrated therein is a block diagram of a system 100 for facilitating proposal and donation of objects, in accordance with an embodiment. The system 100 generally provides a platform for displaying objects for donation, submitting proposals for objects to be donated, settling terms and conditions, meeting formal and regulatory requirements for a donation, and facilitating the physical transfer of donated objects from a donor to a donee (i.e., the recipient of the donated object).

The system 100 includes a donor device 110, operated by a donor who wishes to donate one or more objects such as an artwork. The system 100 includes a donee device 120, operated by a donee who wishes to be a recipient of one or more donated objects. The system 100 includes an administrator device 130, operated by an administrator of the system 100 to configure a backend server 140.

Each of the devices 110, 120, 130 may be a computer, laptop, tablet, smartphone, or the like, having an input interface (e.g., a keyboard, mouse or touch screen), a display (e.g., a screen or touchscreen) and network communication components (e.g., a Wi-Fi transceiver). Each device 110, 120, 130 may be associated with an organization's account and/or one or more users accounts. Any suitable mechanism for associating a device with an account/user of the device is expressly contemplated. Although only one donor device 110 and donee device 120 is depicted, according to other embodiments, the system 100 may include a plurality of donor devices 110 and donee devices 120, each connected to the backend server 140 over the communications network 150.

The devices 110, 120, 130 may connect to, and exchange data with, the backend server 140 over a wireless communications network 150 (i.e., the internet). In some cases, the network 150 may include other types of computer or telecommunication networks. The devices 110, 120, 130 may be installed with a native application (i.e., a software program) for connecting to and exchanging data with the backend server 140.

The backend server 140 may be one or more servers or web (cloud) servers hosting a platform for facilitating proposals and donations of objects. For example, the backend server 140 may host a website or application configured for facilitating proposals and donations of objects as described below. The backend server 140 may be a purpose-built machine designed specifically for receiving and communicating encrypted data in real time from the devices 110, 120, 130 and processing the data. The backend server 140 may be configured to simultaneously communicate with a plurality of donor devices 110 and donee devices 120, and securely transfer data.

The devices 110, 120, 130, 140 further include a memory for storing computer-readable instructions, and a processor coupled to the memory for executing the instructions. The memory may include random access memory (RAM) or similar types of memory. Also, the memory may store one or more applications (i.e., computer programs) for execution by the processor. Applications may correspond to software modules comprising computer executable instructions to perform processing for the functions described below. The applications, computer readable instructions or programs may be stored in memory or in secondary storage, or may be received from the Internet or other network.

Although the devices 110, 120, 130, 140 are described with various components, one skilled in the art will appreciate that the devices 110, 120, 130, 140 may in some cases contain fewer, additional or different components. In addition, although aspects of an implementation of the devices 110, 120, 130, 140 may be described as being stored in memory, one skilled in the art will appreciate that these aspects can also be stored on or read from other types of computer program products or computer-readable media, such as secondary storage devices, including hard disks, solid-state discs, flash memory, floppy disks, CDs, or DVDs; a carrier wave from the Internet or other network; or other forms of RAM or ROM. The computer-readable media may include instructions for controlling the devices 110, 120, 130, 140 to perform a particular method.

In the description that follows, the devices 110, 120, 130, 140 are described performing certain acts. It will be appreciated that any one or more of these devices 110, 120, 130, 140 may perform an act automatically or in response to an interaction by a user of that device. That is, the user of the device may manipulate one or more input devices (e.g., a touchscreen, a mouse, or a button) causing the device to perform the described act. In many cases, this aspect may not be described below, but it will be understood.

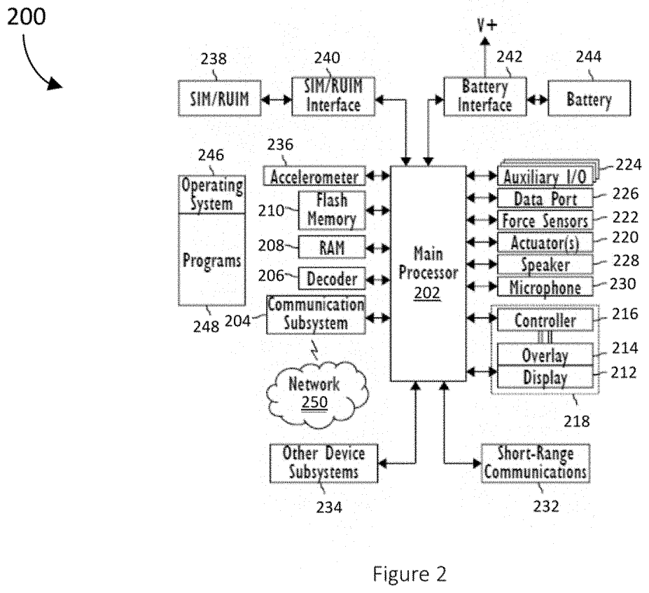

FIG. 2 shows a simplified block diagram of components of a device 200, such as a mobile device or a portable electronic device. The device 200 may be for example any of the devices shown in FIG. 1. The device 200 includes a processor 202 that controls the operations of the device 200. Communication functions, including data communications, voice communications, or both may be performed through a communication subsystem 204. The communication subsystem 204 may receive messages from, and send messages to, a wireless network 250. Data received by the device 200 may be decompressed and decrypted by a decoder 206.

The wireless network 250 may be any type of wireless network, including, but not limited to, data-centric wireless networks, voice-centric wireless networks, and dual-mode networks that support both voice and data communications.

The device 200 may be a battery-powered device and as shown includes a battery interface 242 for connecting one or more rechargeable batteries 244.

The processor 202 also interacts with additional subsystems such as a Random Access Memory (RAM) 208, a flash memory 210, a display 212 (e.g. with a touch-sensitive overlay 214 connected to an electronic controller 216 that together comprise a touch-sensitive display 218), an actuator assembly 220, one or more optional force sensors 222, an auxiliary input/output (I/O) subsystem 224, a data port 226, a speaker 228, a microphone 230, short-range communications systems 232 and other device subsystems 234.

In some embodiments, user-interaction with the graphical user interface may be performed through the touch-sensitive overlay 214. The processor 202 may interact with the touch-sensitive overlay 214 via the electronic controller 216. Information, such as text, characters, symbols, images, icons, and other items that may be displayed or rendered on a portable electronic device generated by the processor 202 may be displayed on the touch-sensitive display 218.

The processor 202 may also interact with an accelerometer 236 as shown in FIG. 2. The accelerometer 1360 may be utilized for detecting direction of gravitational forces or gravity-induced reaction forces.

To identify a subscriber for network access according to the present embodiment, the device 200 may use a Subscriber Identity Module or a Removable User Identity Module (SIM/RUIM) card 238 inserted into a SIM/RUIM interface 240 for communication with a network (such as the wireless network 250). Alternatively, user identification information may be programmed into the flash memory 210 or performed using other techniques.

The device 200 also includes an operating system 246 and software components 248 that are executed by the processor 202 and which may be stored in a persistent data storage device such as the flash memory 210. Additional applications may be loaded onto the device 200 through the wireless network 250, the auxiliary I/O subsystem 224, the data port 226, the short-range communications subsystem 232, or any other suitable device subsystem 234.

For example, in use, a received signal such as a text message, an e-mail message, web page download, or other data may be processed by the communication subsystem 204 and input to the processor 202. The processor 202 then processes the received signal for output to the display 212 or alternatively to the auxiliary I/O subsystem 224. A subscriber may also compose data items, such as e-mail messages, for example, which may be transmitted over the wireless network 250 through the communication subsystem 204.

For voice communications, the overall operation of the device 200 may be similar. The speaker 228 may output audible information converted from electrical signals, and the microphone 230 may convert audible information into electrical signals for processing.

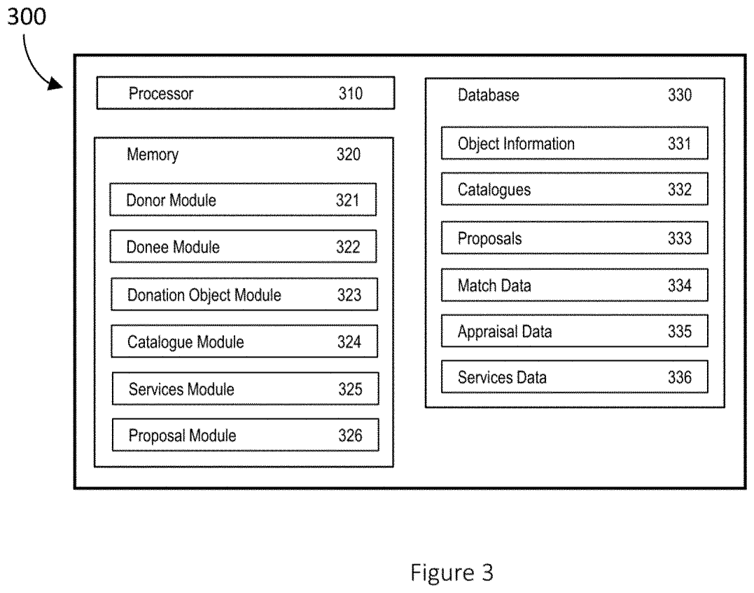

FIG. 3 is a box diagram of a backend server 300 for hosting a platform for facilitating proposal and donation of an object, according to an embodiment. The backend server 300 may be the backend server 140 shown in FIG. 1.

The backend server includes a database 330 for storing a plurality of data. The database 330 stores object information 331 received from donor devices. According to other embodiments, the database 330 may be hosted by a separate server connected to the backend server 300.

The database 330 stores catalogues 332. The catalogues 332 include a subset of the object information 331 that has been validated by an administrator for display in a catalogue. The catalogues 332 may be created by a system administrator to group similar objects into a catalogue. The database 330 includes proposals 333 received from a plurality of donee devices. The proposals 333 may be subdivided into proposals validated by an administrator and proposals that are rejected. The database 330 stores match data 334 including the outcome of inspections, evaluations and ratifications of objects offered for donation. The database 330 stores appraisal data 335 including the appraised value of objects offered for donation. The database 330 stores services data 336 including information pertaining to ancillary services for donating objects including appraisal services, transportation/shipping services, insurance services, etc.

The backend server 300 includes processor 310 and a memory 320 for storing a plurality of processor-executable modules. The memory 320 includes a donor module 321 comprising instructions for receiving, processing and storing data, for example object information 331, from donor devices. The donor module 321 further includes instructions for transmitting data, for example proposals 333, from the backend system 300 to a donor device.

The memory 320 includes a donee module 322 comprising instructions for receiving, processing and storing data, for example proposals 333, from donee devices. The donee module 322 further includes instructions for transmitting data, for example catalogues 332, from the backend system 300 to a donee device.

The memory 320 includes a donation object module 323 comprising instructions for assigning objects to one or more catalogues 332 based on object information 331. For example, the donation object module 323 may include instructions to add objects to a catalogue 332 based on terms and conditions in the object information 331.

The memory 320 includes a catalogue module 324 comprising instructions for making catalogs 332 accessible/viewable to donee devices. For example, the catalogue module 324 may include instructions for making a particular catalogue 332 accessible for a specified period of time or a range of dates.

The memory 320 includes a services module 325 comprising instructions for connecting to and exchanging data with external ancillary services, for example an appraisal service, a transportation/shipping service and an insurance service.

The memory 320 includes a proposal module 326 comprising instructions for storing and sending approved proposals 333 to a donor device at the end of a submissions period.

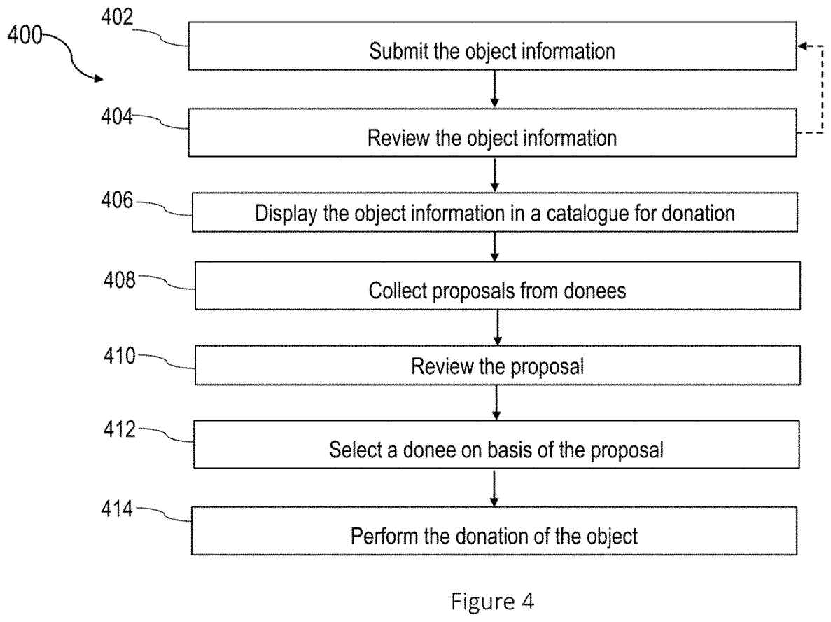

FIG. 4 is a flow diagram of a method 400 for submitting an object for donation, review and display of the object on a catalogue, submitting a proposal to receive the object, and selecting the proposal to donate the object, according to an embodiment. The method 400 may be performed using the system 100 in FIG. 1. For reference, in the description of the method 400, the elements from FIG. 1 are identified in parenthesis.

At 402, the donor provides object information. The object information may include details or specification of the object to be put up for donation. The donor may enter the object information using the donor device (110). The object information entered by the donor is received and stored by the backend server (140).

The object information may include, for example, photographs of the object, a description of the object including the type of object, the subject matter of the object, the condition of the object, the acquisition details of the object, the location of the object, the name of the artist who created the object, the historical background of the object, the date of creation of the object, the provenance documents related to the object, the dimensions of the object, the type of materials used in the object such as acrylic or oil or watercolors, the ownership ties of the donor to the object, any third party authentication of the object, and a list of previous owners.

According to an embodiment, the object information may include a list of terms and conditions set by the donor. The terms and conditions may include, for example, stipulations that the donee must abide by such as placement conditions for the donee, restrictions on further sale or donation of the object, restrictions on modifying or disassembling the object, preference for donees from a geographical location, and certain rights to the object that the donor may prefer not to transfer.

At 404, an administrator of the system (100) reviews the object information using an administrator device (130) to determine whether approval should be given to display the object and object information in a catalogue for viewing by donees. The administrator may review the object information to verify the authenticity of the object. For example, the administrator may review the object information to verify the ownership (chain of title) of the donor to the object. The administrator may review any additional details provided in the object information by the donor. The administrator may determine whether the object may be added to a catalogue for display based on an administrator policy or a seasonal catalogue trend.

The administrator of the system (100) may reject the object and/or object information from being displayed in the catalogue. Alternatively, the administrator of the system may hold the approval process pending receipt of additional object information. The administrator of the system may communicate any missing or insufficient information in the object information as uploaded by the donor. The missing or insufficient information may relate to the resolution of the photograph or the dimensions of the object. The donor may thereafter provide additional object information to address the concerns raised by the administrator. Subsequent to receiving the additional object information, the administrator of the system may provide an approval for displaying the object and object information in the catalogue for display to donees.

At 406, upon receiving approval for the object information by the administrator of the system (100), the object and object information is displayed in the catalogue as an object for donation. The backend server (140) may be configured by an administrator of the system (100), using the administrator device (130) to automatically display the object information in the catalogue upon receiving approval at Act 404. The object and object information may be viewed in the catalogue by a plurality of prospective donees using respective donee devices (120).

According to an embodiment, using the administrator device (130), the administrator of the system (100) may limit the object information to be displayed on the catalogue. For example, the administrator of the system may choose to display only the photograph of the object, the name of the creator, the dimensions of the object, the type of materials used in the object, the location of the object, and a brief description of the object. The administrator may modify the object information as received from the donor before displaying the object information on the catalogue.

According to an embodiment, the backend server (140) may be configured to keep the name of the donor anonymous when displaying on the object in the catalogue for donation. The backend server (140) may be further configured to maintain anonymity of the donor throughout the donation process.

According to an embodiment, the administrator of the system (100) may limit the visibility of the catalogue of objects set for donation to a select geographic region or a demography of donees. For example, the administrator of the system (100) may configure the system to display the catalogue of objects set for donation only for donees located in New York state. Additionally, the administrator may configure the system to display the catalogue of objects for donation only for donee museums granting access gratis to the public.

At 408, a donee after reviewing the catalogue of objects for donation on a donee device (120) may select an object of interest for accessioning and submit a proposal to demonstrate the prospective donee's interest in the object. Additionally, the proposal may describe how the prospective donee meets the terms and conditions, if any, set by the donor. The proposal may be entered on a donee device (120) and received by the backend server (140).

According to an embodiment, the proposal may include the name, contact information, and location of the prospective donee. The proposal may include the name and contact information of a representative of a donee museum. The representative of the donee museum may be a member of the curatorial staff of the donee museum assigned the responsibility of managing the donation on behalf of the donee museum to facilitate the donation process. An administrator of the donee may invite the members of curatorial staff of the donee to register as users of the system (100) using the donee device (120). At registration, the staff members may provide their name, designation, and contact information. The administrator of the donee may select from the list of registered users of the system (100), a representative for managing the donation on behalf of the donee.

According to an embodiment, the donee museum may submit the object of interest for curatorial review to the members of curatorial staff to determine whether the proposal is to be submitted.

Further, the system may be configured to keep the identity of the representative of the donee anonymous. The system may be configured to disclose the identity of the representative of the donee only after the donee is selected as the recipient for the donation of the object. Irrespectively, the name of the donee may be displayed in the proposal.

Alternatively, the system may be configured to open an account for the donee on the donation platform. The administrator of donee may provide details on the list of curatorial staff of the donee museum at the time of creation of the donee account. The details on the list of curatorial staff may include the name of the staff member, designation of the staff member and contact information. The list of curatorial staff for the museum may be put on display at the time of submission of the proposal. The administrator of donee museum may select a representative from the list of curatorial staff displayed to communicate on behalf of the donee museum for a particular proposal. The administrator of donee museum may further select a default representative from the list of curatorial staff displayed to communicate on behalf of the donee museum for all proposals. The system described herein may be configured to display the profiles of the default representatives and the representative selected for the particular proposal at the time of submission of the proposal.

According to an embodiment, the proposal may include a letter of interest. The letter of interest may include details on the donee museum such as the inventory, artifacts currently on display, the object's appropriateness for the museum's collection, the exhibition program of the museum, history of the museum, collections on the same artist, general audience in the museum, donation policy of the museum, curatorial practices of the museum, and standard operating procedures for maintenance of donated inventory.

The proposal may also include a plurality of contextual images from the donee museum. The contextual images may provide the donor with a context towards the potential donation of the object. The contextual images may include a floor plan of the donee museum, the arrangement of artworks displayed in the donee museum, photographs of related artworks in the collection of donee museum, and the potential location to display the object offered for donation. The system may be configured to choose the images from the gallery of the device of the donee museum. Alternatively, the administrator of the donee museum may capture an image in real time to be submitted in the proposal.

According to an embodiment, the administrator of the donee museum may provide a brief textual description for each of the plurality of contextual images. The textual description may include details on the contextual image such as whether it represents a related artwork from the collection of the donee museum and the name of the artist of the artwork. The textual description may include the suggested placement in the art gallery of the object for prospective donation to the donee museum.

According to an embodiment, at the time of submission of the proposal, the donee museum may give consent to the terms and conditions set by the donor of the object. The system as described herein may display at the time of submission of the proposal, the terms and conditions set by the donor of the object. The administrator of the donee museum may review the terms and conditions before submitting the proposal. The administrator of the donee museum may accept or reject the terms and conditions set by the donor of the object.

Further, the administrator of the donee museum may require a clarification on the terms and conditions set by the donor of the object at the time of submission of the proposal. If the clarification is required, the system may populate a text box for the administrator of the donee museum to provide details on the clarification required. The administrator of the donee museum may suggest an alternative to the terms and conditions set by the donor in the clarification section.

According to an embodiment, at the time of submission of the proposal, the administrator of the donee museum may also include shipping information for the object. The shipping information for the object may include whether the donor or the donee will cover the cost of shipping of the object set for donation.

It is to be understood that the details of the proposal mentioned herein are not exhaustive and additional information or data may be presented in the proposal.

The donee museum may submit proposals for a plurality of objects displayed in the catalogue for donation.

The plurality of donee museums may submit proposals until the end of a submission period for receiving proposals as set for the donation catalogue by the administrator of the system.

At 410, once a proposal is submitted by the donee museum, the administrator of the system (100) may conduct a review of the proposal using the administrator device (130). The administrator of the system (100) may determine the validity of the proposal before sending the proposal to the donor for review. For example, the administrator of the system may decline to approve a proposal that appears frivolous.

At 412, at the expiry of the submission period for receiving proposals, the proposals approved by the administrator of system are transmitted to the donor device (110) for review by the donor. The system may be configured to automatically display the approved proposals to the donor at the expiry of the submission period, such that all approved proposals are presented to the donor at the same time, regardless of when the proposal was received during the submission period. The donor may review the proposals submitted by the donees for the object. At the first instance, the donor may be presented the plurality of donees, their contact information who have submitted the proposals for the object set for donation.

Alternatively, the system may be configured to present proposals to the donor instantly (i.e., on a rolling basis) on the approval of the proposal by the administrator of system (100).

The donor may navigate the plurality of donee museums to review the proposals submitted by each of them. The proposal may be arranged to include the name of the donee museum and the contact information, followed by the letter of interest by the donee museum. Further, the proposal may also include contextual images with their respective description, if any. Thereafter, the proposal may include the terms and conditions set by the donor and whether the donee museum has accepted the terms and conditions. If the donee museum has requested clarification of the terms and conditions, the details on the clarification required may also be displayed. Finally, the proposal may include the shipping information and the payment option selected by the donee museum to cover the cost of shipping.

According to an embodiment, if the donee museum has requested clarification on the terms and conditions set by the donor, the donor may respond to the clarification required. The donee museum on receiving the clarification may choose to proceed with the proposal or rescind the proposal.

The donor may accept one proposal from the plurality of proposals submitted on the object. On confirming the proposal, the donor may submit the donation form for the object.

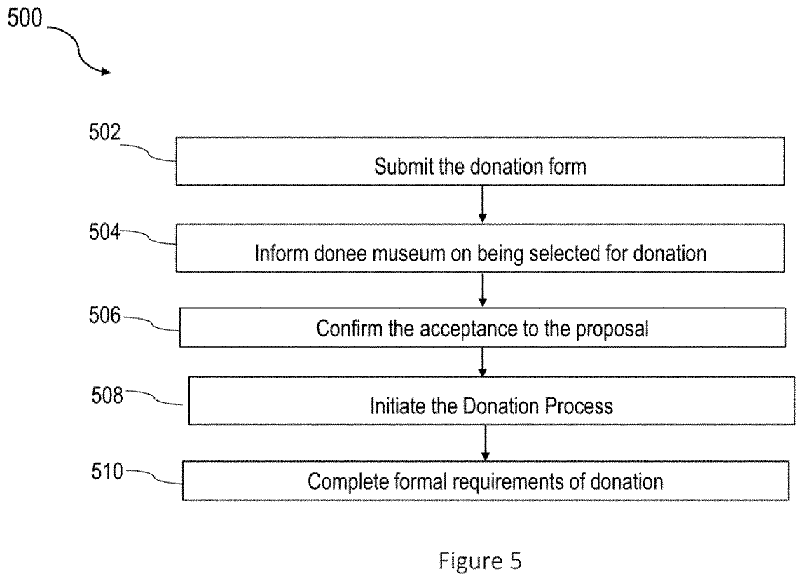

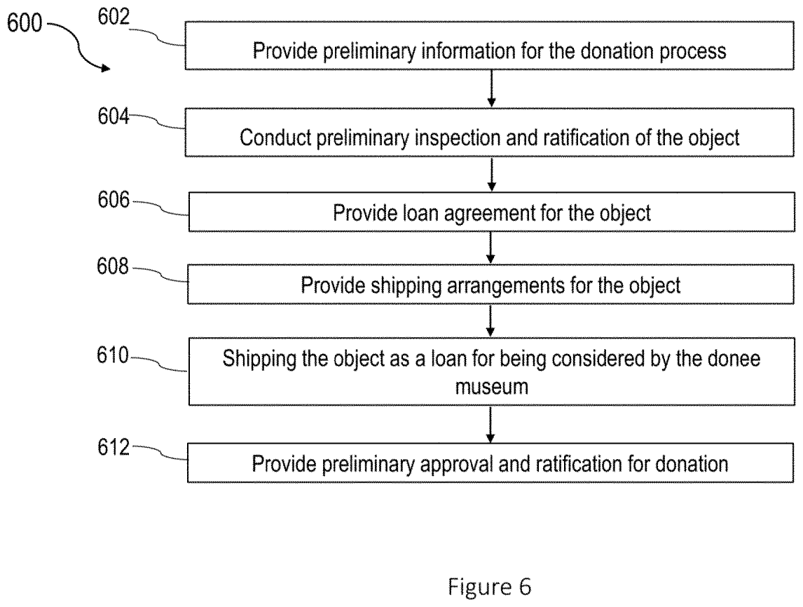

According to an embodiment, the donor may accept or reject a proposal before the expiry of a time period set by the system. At 414, the system completes the formal requirements to simplify and expedite the donation process. Act 414 includes the formal requirements include the accessioning of the object, completion of donor information form, review of the object by the donee museum, performing an appraisal of the object, conducting an assessment of the object and completion of all required tax forms for the donation. Method 500 of FIG. 5 and method 600 of FIG. 6 describe various embodiments of Act 414.

FIG. 5 is a flow diagram of a method 500 for accessioning the object after selecting a proposal, according to an embodiment. Method 500 occurs at step 414 of method 400, therefore it is to be understood that steps 402-412 of method 400 have occurred before step 502. The method 500 may be performed using the system 100 in FIG. 1. For reference, in the description of the method 500, the elements from FIG. 1 are identified in parenthesis.

At 502, upon accepting a proposal, the donor may submit a donation form providing details to initiate the donation process. The donation form may be filled out by the donor using the donor device (110) and is received by the backend server (140). The details for the donation form may include whether the donor is the owner of the object set for donation, or a representative of the owner is submitting the donation form. Additional details to be submitted on the donation form may include the donor's legal name, whether the donor is an individual, a couple or an institution/entity, the donor's primary mailing address to be used on official documents for donation, and the credit line of the donor. The credit line refers to the label or caption displayed along the donated object at exhibitions, publications, and publicity materials. For example, a credit line may include: “Gift of John and Jane Doe”; “Gift of Jane Doe in memory of her husband John Doe”; “Gift in Memory of John Doe”; “Anonymous Gift” etc.

At 504, on submission of the donation form by the donor, the donee is notified on being selected as the recipient for the donation of the object. A notification may be sent to the donee device (120) from the backend server (140) to inform the donee. The donation process is initiated after the donee confirms the donor's acceptance for the proposal. Before confirming the acceptance, the donee is presented the donor information. The donor information includes object summary, name of the donor, primary location of the donor, name of the representative from the curatorial staff of the donee museum selected to handle the donation of the particular object, and the location of the object. At this step, the anonymity for the donor may be waived and the identity of the donor may be revealed to the donee.

If no response is received from the donee after the submission of the donation form, the donor may contact the donee over the system (100) to confirm the status of donation. A donor platform may be configured to display the list of active objects and inactive objects for donation. The active objects may display the objects currently in progress for donation. Alternatively, the inactive objects may include objects that have been donated.

At 506, the donee upon receiving the donor's acceptance to the proposal may confirm the acceptance after reviewing the donor information.

According to an embodiment, the donee museum may confirm or reject a donor's acceptance to the proposal before the expiry of a time period set by the system administrator.

At the time of confirming the acceptance to the donee museum's proposal to the donor, the donee may assign a registrar for the donation. The donee may further provide the name and contact information of the assigned registrar. The registrar may be an agent of the donee museum. The registrar may be a member of curatorial staff of the donee or another registered user of the system(100). On being assigned, the registrar will be the designated representative to respond to the formal requirements, provide documentation and signatures for the donation process. The donee may assign or reassign specific steps of the donation process to other members of the staff at any point. Further, the system is configured to link all the accounts of the staff of the donee museum. The members of the staff of the donee museum may follow the donation in progress including updates in real time from the system.

At 508, the donation process is initiated once the donee confirms the donor's acceptance to the donee museum's proposal. The donee museum may review on the system (100), the proposal history and review the proposals currently under consideration of the administrator of the system for donor's review, or under the consideration of the donor, or the proposals that have been accepted by the respective donors.

At 510, the formal requirements of donation are completed.

According to an embodiment, the formal requirements of donation may include concluding a Deed of Gift between the donor and donee museum. A Deed of Gift is prepared for the object set for donation. The Deed of Gift transfers title and ownership of the object from the donor to the donee museum. The Deed of Gift may be signed by the donor. The Deed of Gift may be countersigned by the donee museum. The Deed of Gift may be prepared by the donee museum and uploaded to the system. The system may transmit the Deed of Gift to the donor for signing. The Deed of Gift may be signed electronically by the donor.

The Deed of Gift may specify the donor's preferred credit line. The Deed of Gift may indicate the name and contact information of the donor and the donee museum. A tax receipt may be issued for the year in which the Deed of Gift is fully executed.

According to an embodiment, the administrator of the donee museum may assign the signees to countersign the Deed of Gift. The signees of the donee museum may be members of the staff of the donee museum registered on the system described herein. At the time of assigning the signees to countersign the Deed of Gift, the system described herein may display the list of registered members of the staff of the donee museum and their respective designations. The Deed of Gift may be countersigned electronically by the assigned signee of the donee museum after the Deed of Gift is signed by the donor.

According to an embodiment, other formal documents may be prepared after the Deed of Gift is concluded. The other formal documents may be prepared to comply with the legal requirements of the relevant regulatory or taxation authorities to report information about donations and charitable contributions. The other formal documents may include a Form 8283 for the Internal Revenue Service, USA. The Form 8283 may be prepared by the donor. The Form 8283 may include description on the object. The Form 8283 may be signed by the donor, the appraiser and donee museum.

On completion of all the formal requirements of donation, the system may display a list of tasks completed.

FIG. 6 is a flow diagram of a method 600 for completing the donation after confirming the donor's acceptance to the donation, according to an embodiment. Method 600 occurs at step 510 of method 500, therefore it is to be understood that steps 502-508 of method 500 have occurred before step 510. The method 600 may be performed using the system 100 in FIG. 1. For reference, in the description of the method 600, the elements from FIG. 1 are identified in parenthesis.

At 602, the donor and donee provide the donor preliminary information and donee preliminary information respectively.

The donor submits the donor preliminary information including the physical address to pick up the object, the contact information of the donor or his/her representative responsible for the shipping and general availability. In general availability, the donor may provide a preferred time and location for pick up of the object, restrictions, if any, and pre-shipping inspections, if required.

Additionally, the donor may provide object shipping information to facilitate the donee museum with arranging shipping and preparing a loan agreement. The object shipping information includes the weight of the object, whether the object is framed, the dimensions of the object (height, width and depth). The donor may provide condition notes to describe any fragility or handling concerns pertaining the conditions of the object. The donor may provide an insurance value of the object for shipping purposes.

Additionally, the donor may provide details if there is an existing crate to pack the object. The donor may provide the dimensions of the crate and the gross weight of the crate. Further, the donor may suggest whether the shipper can pack the object on site of pick up. Furthermore, the donor may provide any special instructions for shipping and loan agreement.

At 604, the object set for donation is inspected by the representatives of the donee museum before accepting the offer for donation. The administrator of the donee museum may provide donee preliminary information. The donee preliminary information may include approval dates and pre-shipping information. The approval dates may refer to the expected date when the object is presented for inspection or acquisition consideration by the representatives of the donee museum. The approval dates may refer to the date for preliminary approval consideration by the donee museum.

The approval dates may refer to the expected date of ratification meeting. Ratification may include an assessment of the object set for donation by the representatives of the donee museum to verify the provenance, quality, legal obligations or constraints, chain of ownership or other details related to the credibility and relevance of the object set for donation. Ratification of the object may refer to the decision made by the donee museum to accept the object set for donation.

The donee museum may provide separate approval dates for preliminary approval consideration and ratification of the object.

The system may be configured to require the donee museum to provide an outcome of the acquisition consideration meetings including preliminary approval meeting or ratification meetings. The outcome may include whether the donee museum has consented to accept the donation of the object, or the donee museum has rejected the donation of the object. If the donee museum rejects the donation of the object, the donee museum may provide the reason for declining the offer for donation. For example, the reason may include that the actual condition of the object is not the same as described by the donor.

Additionally, while providing approval dates, the donee museum may provide the dates for preliminary approval. The donee museum may not specify a date for preliminary approval if the approval is expected to be provided upon viewing the object. Alternatively, the donee museum may provide the date on which the scheduled meeting is set for acquisition consideration. Further, the donee museum may decline to provide any preliminary approval information.

Additionally, while providing approval dates, the donee museum may provide the expected ratification date for acquisition consideration of the object. The donee museum may not specify a date for ratification if the ratification is expected to be provided upon viewing the object. Alternatively, the donee museum may provide the date on which the scheduled meeting is set for ratification. Further, the donee museum may decline to provide any ratification information.

According to an embodiment, the donee museum may conduct a donation consideration of the object before accepting the donation. The donation consideration may include shipping the object as a loan (i.e., for a trial period) to the donee museum. On receiving the loaned object, the donee museum may assess the object before determining whether or not to accept the donation.

The donee museum may provide pre-shipping inspection information. The pre-shipping inspection information may include donee museum's preference on whether an inspection of the object will be required prior to the shipping. The donee museum while requiring a pre-shipping inspection may request a condition report, or a conservator inspection with a condition report, or shipper site visit.

At 606, the donee museum provides a loan agreement for the object. The loan agreement may be required for an object to be shipped to the donee museum for being considered for acceptance by the museum. The object will retain the status of a “loaned object” until it is considered and accepted by the donee museum.

The system may automatically prompt all the registered users of the curatorial staff to complete the loan agreement. The prompt may be generated in form of an email sent to a donee device (120). The prompt may include a request for assigning an agent for the task of completing the loan agreement.

If the administrator of the donee museum has assigned a registrar for donation process, the assigned registrar may be assigned by default as the agent for completion of the loan agreement.

Alternatively, the administrator of the donee museum may assign a loan agreement agent with the task of completing the loan agreement. The administrator of the donee museum may further provide the name and contact information of the loan agreement agent. The loan agreement agent may be an agent of the donee museum. The loan agreement agent may be a member of staff of the donee museum. The loan agreement agent may be a registered user of the system described herein. On being assigned, the loan agreement agent will be the designated representative to respond to the formal requirements, provide documentation and signatures for the loan agreement in donation process. The system may be configured to direct all loan agreement related tasks and correspondence to the loan agreement agent. The administrator of the donee museum may assign or reassign specific steps for completion of the loan agreement to other members of the staff at any point. Further, the system described herein links all the accounts of the staff of the donee museum. The members of the staff of the donee museum may follow the completion of loan agreement in progress including updates in real time from the system.

According to an embodiment, the donee museum may assign a plurality of loan agreement agents the task of completing the loan agreement.

The completed loan agreement may be transferred over the system to the donor device (110) for review and consent. After receiving the consent to the loan agreement from the donor, the system described herein may automatically transmit the loan agreement to the donee museum. The administrator of the donee museum on receiving the donor signed loan agreement may countersign the loan agreement. The administrator of the donee museum may assign a representative for countersigning the loan agreement. The administrator of donee museum may select a representative from the staff members of the donee museum registered to the system described herein for countersigning the loan agreement. Alternatively, the administrator of the donee museum may invite the assignee for countersigning the loan agreement by sending an invite on from the system. The invite may include the email address of the assignee for countersigning the loan agreement.

According to an embodiment, the donee museum may assign a plurality of assignees to countersign the loan agreement loan agreement.

The system described herein may be configured to receive digital signatures and countersignatures to the loan agreement by the donor and administrator of the done museum.

At step 608, the representative of the donee museum provides shipping arrangements for scheduling the pickup for the object. The object may be shipped to the donee museum for assessment as a loaned object. The cost incurred on the shipping and insurance of the loaned object may be incurred by the donee museum. Alternatively, the donor may undertake to pay the cost incurred in shipping and insurance of the loaned object.

The system described herein may automatically prompt all the registered users of the curatorial staff of the donee museum to provide shipping arrangements for scheduling the pickup for the object. The prompt may be generated in form of an email. The prompt may include a request for assigning a shipping arrangement agent for providing shipping arrangements for scheduling the pickup for the object.

If the donee museum has assigned a registrar for donation process, the assigned registrar may be assigned by default as the shipping arrangement agent for providing shipping arrangements for scheduling the pickup for the object.

Alternatively, the donee museum may assign a shipping arrangement agent the task of providing the details for shipping arrangement. The donee museum may further provide the name and contact information of the shipping arrangement agent. The shipping arrangement agent may be an agent of the donee museum. The shipping arrangement agent may be a member of staff of the donee museum. The shipping arrangement agent may be a registered user of the system described herein. On being assigned, the shipping arrangement agent shall be the designated representative to respond to the formal requirements, provide documentation and signatures for the shipping arrangement in donation process. The system described herein may be configured to direct all shipping arrangement related tasks and correspondence to the shipping arrangement agent. The donee museum may assign or reassign specific steps for completion of the shipping arrangement to other members of the staff at any point. Further, the system described herein links all the accounts of the staff of the donee museum. The members of the staff of the donee museum may follow the completion of shipping arrangement in progress including updates in real time from the system.

At 610, the object is shipped as a loaned object for acquisition consideration and ratification of the object set for donation.

At 612, the representatives of the donee museum, upon conducting the preliminary investigation of the object, if any, or acquisition consideration, if any, provide the ratification to acquire the object.

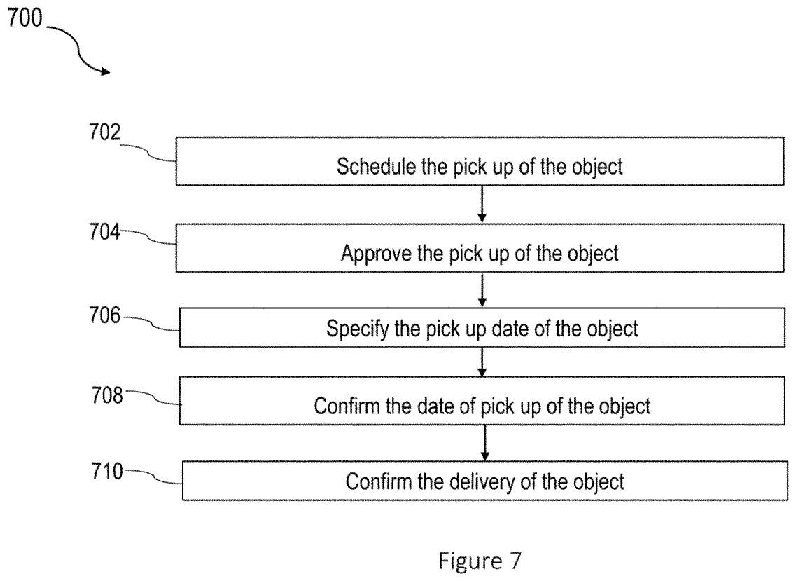

FIG. 7 is a flow diagram of a method 700 for providing shipping arrangements for the object set for donation, according to an embodiment. Method 700 occurs at step 608 of method 600, therefore it is to be understood that steps 602-606 of method 600 have occurred before step 702. The method 700 may be performed using the system 100 in FIG. 1. For reference, in the description of the method 700, the elements from FIG. 1 are identified in parenthesis.

At 702, the administrator of the donee museum or the representative of the donee museum may provide the scheduling information to the system. The administrator of the donee museum or the representative of the donee museum may provide a range of proposed dates for pick up of the object. Alternatively, the administrator of the donee museum or the representative of the donee museum may provide a plurality of proposed dates for pick up of the object.

The proposed dates may be transmitted for approval to the donor. At the time of donee museum's submission of scheduling information, the system may display the preferred time submitted by the donor earlier for the pick up of the object. If the proposed dates submitted by the administrator of the donee museum are not same as the preferred dates submitted by the donor earlier, the system described herein may raise a notification to the administrator of the donee museum to provide other proposed dates.

The administrator of the donee museum or the representative of the donee museum may also provide the details of the object to a shipping company to ship the object from the donor's location to the donee museum. Alternatively, if the object shipping company has sub-contracted another company for pick up in the geographical area of the donor, the administrator of the donee museum may provide the name of the sub-contracted company. The system may generate a list of preferred art shipping companies to schedule the pick up of the object within the general availability and the location of the donor. The list of preferred art shipping companies may be previously stored in the system by the donee museum.

At 704, the donor may approve the proposed dates for pick up of the object earlier submitted by the donee museum. The system presents the donor the proposed dates for pick up submitted by the administrator of the donee museum. The system may also display the name of the art shipping company, and shipping sub-contractor company, if any. If the donor does not provide the approval to the proposed dates submitted by the administrator of the donee museum, the system may require the donor to provide rescheduling notes and preferred dates for the donee museum. If the donor does not provide the approval to the proposed dates, the method 700 may be restarted from 702.

At 706, after the proposed pick up dates submitted by the donee museum are approved by the donor, the donee museum may provide specific dates for pick up. It is to be understood that proposed pick up dates submitted by the donee museum in step 702 and the dates approved by the donor in step 704 are generally an approximate range of dates. For example, the proposed dates by donee museum and approved dates by the donor may be 1st January 2021 to 10 Jan. 2021.

According to an embodiment, the donee museum may provide a plurality of specific dates and time for the pick up.

At 708, the donor may confirm one date and time from the list of specific dates for pick up provided by the donee museum for shipping the object. If the donor rejects the specific dates submitted by the donee museum, the method 700 may be restarted from 702.

At 710, the administrator of the donee museum confirms the delivery of the object. The administrator of the donee museum may upload to the system a delivery receipt to confirm the delivery of the object.

The communication of the proposed dates, specific dates by the donee museum, and the approved dates, confirmed dates by the donor may be conducted on the system described herein.

According to an embodiment, the system described herein may be configured to track in real time the status of the shipping of the object set for donation.

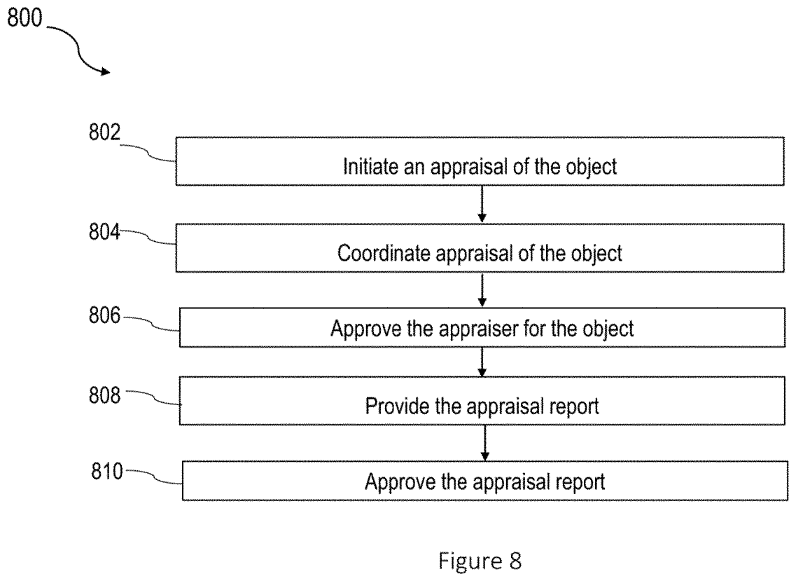

FIG. 8 is a flow diagram of a method 800 for conducting an appraisal of the object set for donation, according to an embodiment. Method 800 occurs after step 612 of method 600, therefore it is to be understood that steps 602-612 of method 600 have occurred before step 802. The method 800 may be performed using the system 100 in FIG. 1. For reference, in the description of the method 800, the elements from FIG. 1 are identified in parenthesis.

At 802, an appraisal of the object set for donation is initiated by the donor and ratified by the donee museum. An appraisal may include a formal evaluation of the object to determine the monetary value of the object. An appraisal of the object may be conducted by a third-party professional appraiser. The appraisal of the object may be conducted for the purpose of tax deduction wherein the appraised value of the object may be deducted from the taxes of the donor. An appraisal report of the object may be prepared by the third-party professional appraiser after conducting the appraisal. The appraisal of the object may be requested either by the donor or the donee museum. The appraisal of the object may be required by the relevant taxation authority.

The system may be configured to require the appraisal be completed within a pre-set time period from the date of ratification meeting. The system may raise a notification for the appraiser to conduct the appraisal before the expiry of the time period to conclude the appraisal.

At 804, the administrator of the system suggests the name of the appraiser, estimated hours required for the appraisal and the expected cost of appraisal. The administrator of the system described herein suggests an appraiser from a pre-stored list of preferred appraisers. Alternatively, the donor may appoint an appraiser of choice. The system described herein uses the images of the object provided previously by the donor for the appraisal process. The appraiser may not require access to the object unless otherwise provided.

At 806, the appraiser suggested by the administrator of the system described herein is informed to the donor. The donor may also be informed the name of the appraiser, estimated hours required for the appraisal and the expected cost of appraisal. The donor may approve the appraiser suggested. Alternatively, the donor may reject the appraiser suggested and request appointment of another appraiser of donor's choice.

At 808, after the appraisal has been conducted, the administrator of the system described herein uploads the appraisal report on the system.

At 810, the donor receives the appraisal report on the system. The donor reviews the appraisal report. The donor may approve the appraisal report. The approval of the appraisal by the donor may complete the appraisal process.

The systems and methods in the present disclosure include donation of an object associated to a non-fungible token. According to an embodiment, the object of donation may include digital objects or physical objects. Non-fungible token may refer to a unique authentication record stored on a distributed ledger. The authentication record may relate to the object of association to the non-fungible token. A non-fungible token may be associated to physical and digital artworks include paintings, photographs, animations, drawings, musical composition or rendition, videos, video games, documents, or any other digital object. The distributed ledger may be implemented as a blockchain. It is to be understood that systems and methods in the present disclosure follow similar series of steps for donation of an object associated with a non-fungible token as described in FIGS. 4, 5, 6, 7, and 8. However, certain steps may be configured to complement the donation process of an object associated to the non-fungible token as provided herein. One skilled in the art will appreciate that further adjustments may be made to meet the implementational requirements for donating and transmitting an object associated with the non-fungible token.

In event of donation of an object associated with the non-fungible token, the donor may store the non-fungible token in a digital wallet. The donor may provide the object information including details or specification of the object to be put up for donation as described in Act 402 of FIG. 4. Additionally, the donor may provide information relating to the non-fungible token associated to the object. The non-fungible token information may be provided in industrial standards for representing non-fungible digital objects. For example, the non-fungible token information may be provided in ERC-721 or ERC-1155 standards. The visual representation of the object associated to the non-fungible token may be presented on the catalogue as described in Act 406. The curatorial review of the object by the donee museum or the administrator of the system (100) may include authenticating the ownership of the object to the donor over a blockchain using the non-fungible token.

In event of donation of an object associated with the non-fungible token, the shipping arrangements of the loaned object as explained in description of FIGS. 6 and 7 may refer to transmitting the non-fungible token to a digital wallet of the donee museum or an escrow digital wallet. Act 602 of FIG. 6 may include the donor and the donee museums providing the digital wallet addresses of their respective digital wallets to the system (100). The system described herein may be configured to connect the digital wallets of the donor and the donee museum to an interface connected to the administrator of the system (100) and backend server (140). Further, the digital wallet address of the escrow digital wallet may be associated to the administrator of the system (100) and the backend server (140).

The loaned object, as explained in description of FIG. 6, may include transmitting the non-fungible token to the digital wallet of the donee museum or the escrow digital wallet, as predetermined by the donor and the donee museum. The inspection or acquisition consideration of the object by the donee museum as described in Act 604 of FIG. 6 may include authentication of the ownership and provenance of the object by verifying the information on the non-fungible token and the distributed ledger. The ratification by donee museum may be based on the result of authentication of the ownership and provenance of the object by validating the non-fungible token. The non-fungible token may be transmitted from the escrow digital wallet to the digital wallet of the donee museum after execution of the Deed of Gift.

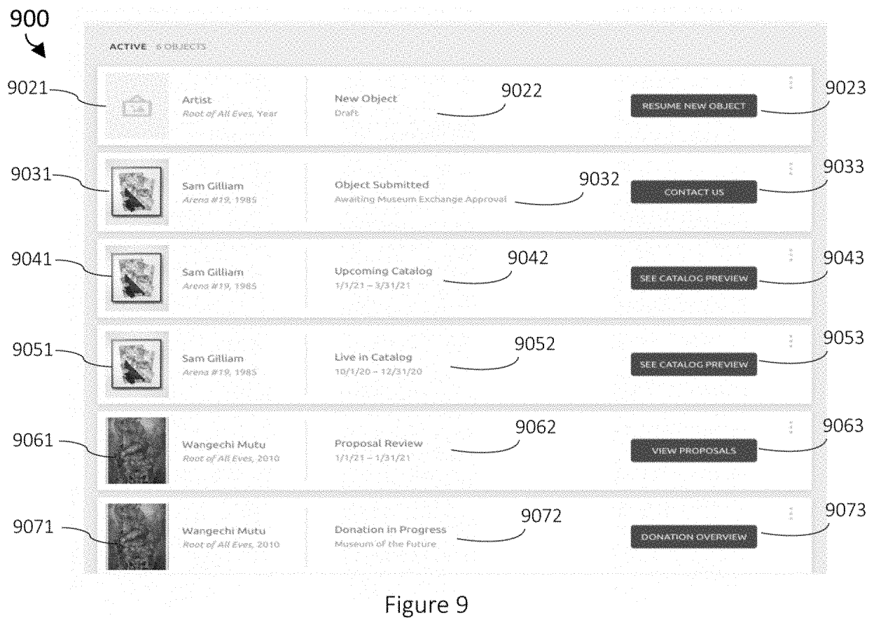

FIG. 9 is an exemplary screen capture of a donor dashboard view 900 displaying active donation processes for a plurality of objects set for donation, according to an embodiment.

The object information 9021 includes the photograph of the object set for donation by the donor. The object information 9021 also include the name of the object, the name of the creator/artist of the object and the year of creation of the object. The action status 9022 represents the status of the object in the donation process. Finally, the action key 9023 represents the key to execute the next function in the donation process for the object represented in the object information 9021.

For example, the object information 9031 represents the image of the object set for donation by the donor, the name of the artist i.e., “Sam Gilliam”, the name of creation/object i.e., “Arena #19”, and the year of creation i.e., 1985. The action status 9032 indicates the object has been submitted to be uploaded on the donation catalogue and the object is currently pending approval from the administrator of the system described herein to publish the object on the catalogue. Finally, the action 9033 provides the donor accessing the donor dashboard view 900 to contact the administrator of the system.

Also shown is object information 9061 which represents the image of the object set in donation, the name of the artist i.e., “Wangechi Mutu”, the name of the object i.e., “Root of All Eves” and the year of creation 2010. The action status 9062 indicates that the proposals have been received for the object. The action status 9062 also indicates the dates within which the donor needs to review the proposals and accept or decline the proposals. The action key 9063 provides a key for the next step in the donation process i.e., reviewing the proposals and approving/rejecting a proposal.

Also shown is object information 9071 which represents the image of the object set in donation, the name of the artist i.e., “Wangechi Mutu”, the name of the object i.e., “Root of All Eves” and the year of creation 2010. The action status 9072 indicates that the proposal has been accepted and the donation is in process. The action status 9072 also indicates the name of the donee museum receiving the donation. The action key 9073 provides the option to review the current status of the donation process i.e., reviewing the formal documents required for donation and their current status for concluding the donation process.

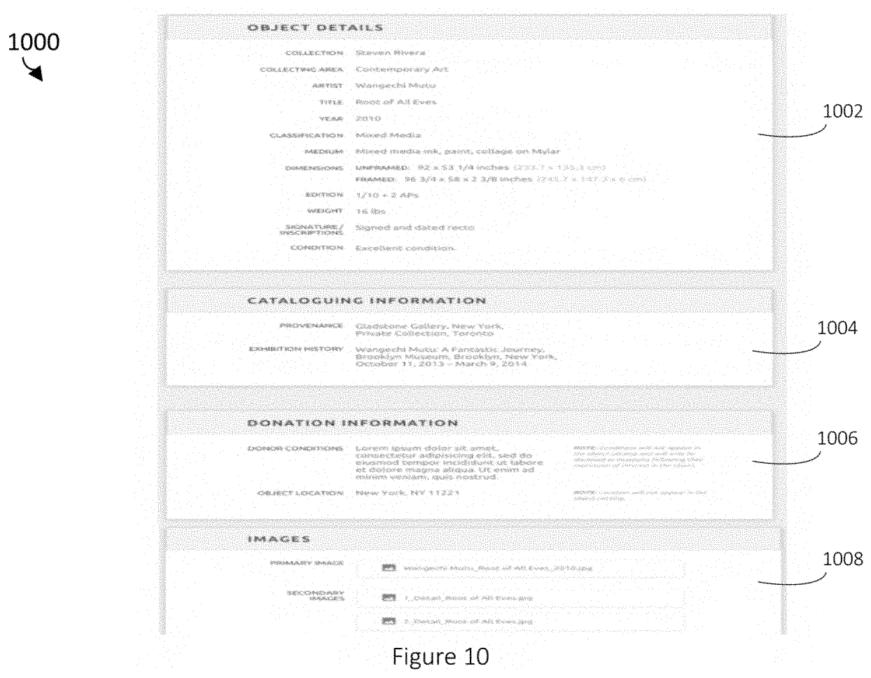

FIG. 10 is an exemplary screen capture of a donor dashboard view 1000 showing summarized object information, according to an embodiment.

The object details 1002 include the owner of the collection “Steven Rivera”, the collecting area “Contemporary Art”, the name of the artist “Wangechi Mutu”, the title of the object “Root of All Eves”, the year of creation “2010”, the classification of the object “Mixed Media”, the medium or the type of materials used “Mixed media ink, paint, collage on Mylar”, the dimensions of the object (unframed, framed), the edition of the object, the weight of the object, the signature/inscriptions of the artist, if any, the donor's assessment on the condition of the object.

The cataloguing information 1004 includes the provenance of the work and the exhibition history of the work.

The donation information 1006 includes the donor's terms and conditions for the donation and the location of the object.

The images 1008 includes the photographs of the object uploaded by the donor.

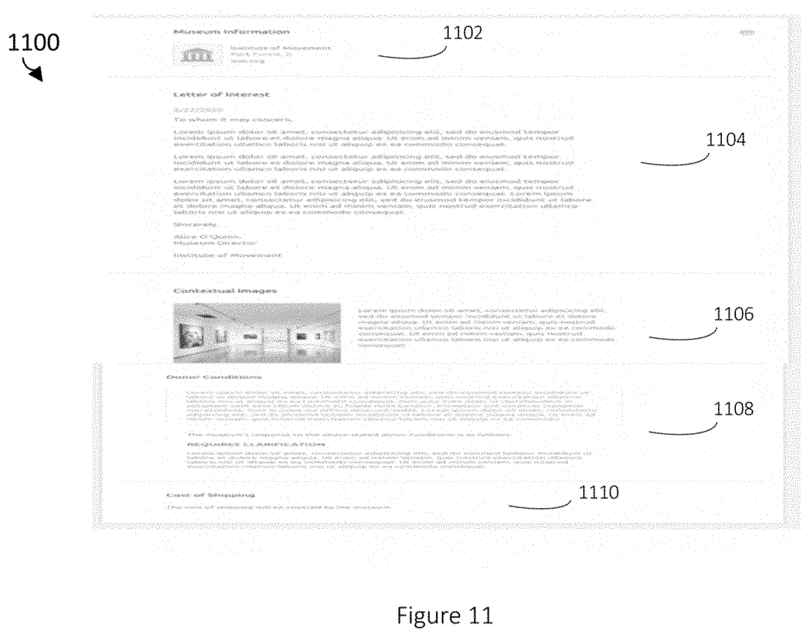

FIG. 11 is an exemplary screen capture of a proposal 1100 for submitting an expression of interest in acquiring an object listed for donation, according to an embodiment.

The proposal includes Museum Information 1102 to identify the donee museum submitting the proposal to acquire the object set for donation. The Museum Information 1102 includes the name of the donee museum, the physical location of the donee museum and a website for the donee museum.

Further, the Letter of Interest 1104 indicates the details to express the donee museum's interest in acquiring the object set for donation. The letter of interest may include details on the donee museum such as the inventory, artifacts currently on display, the object's appropriateness for the museum's collection, the exhibition program of the museum, history of the museum, collections on the same artist, general audience in the museum, donation policy of the museum, curatorial practices of the museum, and standard operating procedures for maintenance of donated inventory.

The contextual images 1106 may provide the donor with a context towards the potential donation of the object. The contextual images may include a floor plan of the donee museum, the arrangement of artworks displayed in the donee museum, photographs of related artworks in the collection of donee museum, and the potential location to display the object offered for donation. The system described herein may be configured to choose the images from the gallery of the device of the donee museum. Alternatively, the administrator of the donee museum may capture an image in real time to be submitted in the proposal.

According to an embodiment, the administrator of the donee museum may provide a brief textual description for each of the plurality of contextual images. The textual description may include details on the contextual image such as whether it represents a related artwork from the collection of the donee museum and the name of the artist of the artwork. The textual description may include the suggested placement in the art gallery of the object for prospective donation to the donee museum.

The donor's conditions 1108 refers to the terms and conditions set by the donor along the offer for donation. Further, the administrator of the donee museum may require a clarification on the terms and conditions set by the donor of the object at the time of submission of the proposal. The clarification required is displayed along the terms and conditions set by the donor.

The cost of shipping 1110 provides that the costs incurred in the shipping of the museum would be paid by the donee museum.

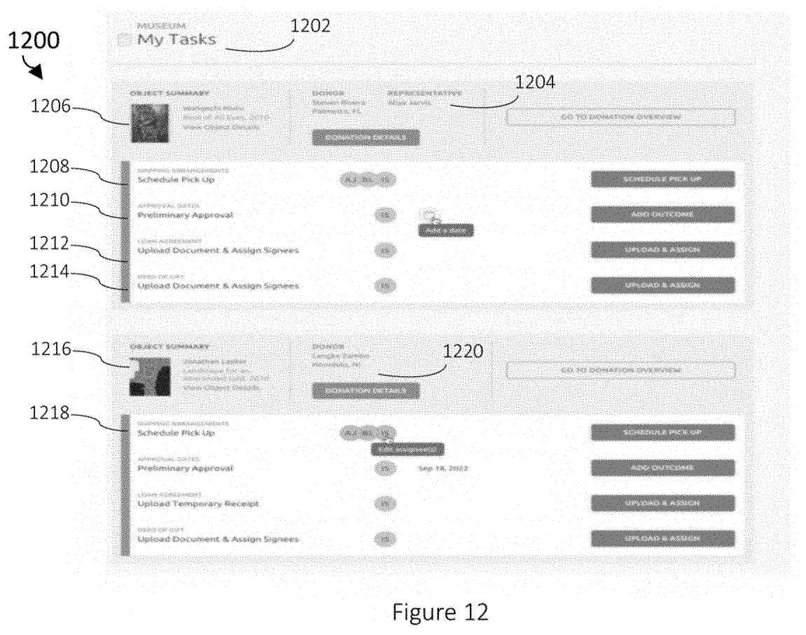

FIG. 12 is an exemplary screen capture of a task manager 1200 for coordinating and performing the tasks in the donation process as viewed by the donee museum, according to an embodiment.

The task manager 1200 provides for management of a plurality of tasks in the donation process pertaining to a plurality of objects 1206, 1216 undertaken by the donee museum.

The object summary 1206 indicates the task management for the object “Root of All Eves” created by “Wangechi Mutu”. The donor information 1204 indicates the name of the donor and the representative of the donor, and the location of the donor offering the object 1206 for donation. The shipping arrangements 1208 indicate the assignees appointed by the administrator of the donee platform for managing the shipping arrangements. Any of the assignees for the shipping information may select the action key to schedule the pick up.

The approval dates 1210 indicate the assignees appointed by the administrator of the donee platform for providing the approval dates and the outcomes of the acquisition consideration meetings. Any of the assignees for the shipping information may select the action key to provide the outcome of the preliminary approval or acquisition consideration meetings. The administrator of the donee museum may select approval dates for the notice of donor. The system is configured to store the outcome of the preliminary approval or acquisition consideration meetings. The notification on the outcome of the preliminary approval or acquisition consideration meeting may be provided in the real to the donor.

The loan agreement 1212 provides for completing and uploading the documents to ship the object as a “loaned object” for preliminary investigation by the donee museum. The administrator of the donee museum may assign the members of the staff of the donee museum to undertake preparation and processing of the loan agreement.

The deed of gift 1214 provides for completing and uploading the documents to transfer the rights of the ownership of object from the donor to the donee museum. The deed of gift is signed after the ratification of the object by the representatives of the donee museum.

The task manager 1200 provides similar management of tasks 1218 for the object with object summary 1216 and donor information 1220.

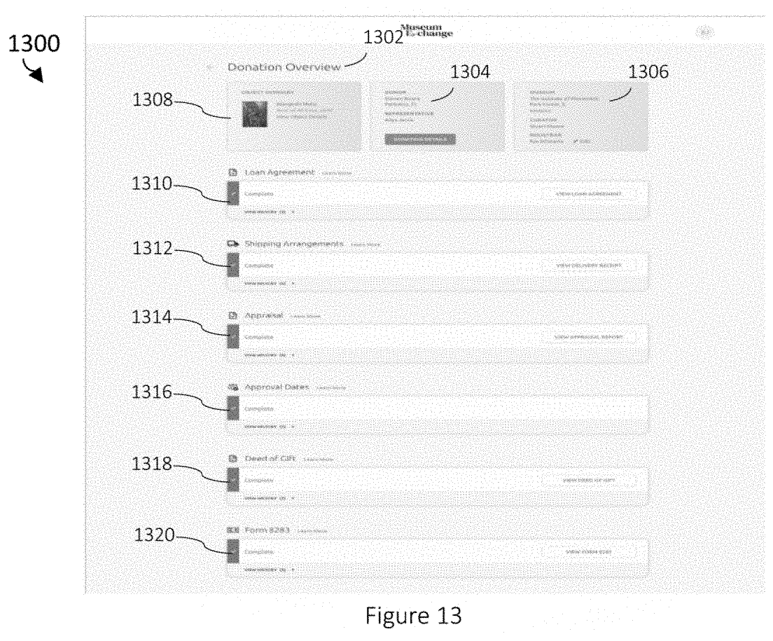

FIG. 13 is an exemplary screen capture of a donation overview 1300 displaying completed status of all the tasks in the donation process as viewed by the administrator of the system, according to an embodiment.

Donation overview 1302 represents the status of each task in the donation workflow represented by tabs 1308, 1310, 1312, 1314, 1316, 1318, 1320. The system described herein is configured to update the status of each tab 1308, 1310, 1312, 1314, 1316, 1318, 1320 in real time upon completion of the respective task. The Donation overview 1302 may be generated to reflect the status of donation workflow including, for example, the status of loan agreement, shipping arrangements, appraisal, approval dates, deed of gift, and Form 8283 as displayed.

Donor information 1304 represents the name of the donor, the address of the donor and the identification of the representative of the donor for the purposes of the donation, if any.

Donee information 1306 represents the name of the donee museum, the address of the donee museum, the website of the donee museum, the curator assigned by the donee museum, and the registrar appointed by the donee museum.

Object information 1308 represent the summary of the object set for donation. The object information 1308 includes the photograph of the object set for donation, the name of the creator, the title of the object and the weblink to further information of the object.

Loan agreement 1310 provides the status of signing of the loan agreement by the donor and the countersigning of the loan agreement by the donee museum.

The loan agreement may be required for an object to be shipped to the donee museum for being considered for acceptance by the museum. The object will retain the status of a “loaned object” until the Deed of Gift 1318 is executed.

Shipping arrangements 1312 provides the status of shipping arrangements decided by the donor and donee museum such as which party undertakes to pay for the shipping and insurance for shipping.

Shipping arrangements 1312 may include further steps as presented by method 700 in FIG. 7.

Appraisal 1314 presents the status of appraisal conducted by an appraiser to determine the value of the object set for donation.

Approval Dates 1316 represent the dates suggested by the donee museum for preliminary investigation and ratification for acquisition of the object set for donation.

Deed of Gift 1318 provides the status of preparation of the Deed of Gift by the donee museum, the electronically signing of the Deed of Gift by the Donor and the electronically signing of the acknowledgement to the Deed of Gift by the Donee Museum.

Form 8283 1320 represents the status of Form 8283 required by the Internal Revenue Service, USA to comply with the legal requirements for claiming tax deduction for making a donation or charitable contribution. The Form 8283 may be generated by the administrator of the system (100) based on the object information provided by the donor and the appraisal information provided by the appraiser. The Form 8283 may include description on the object. The Form 8283 may be signed by the donor, the appraiser and donee museum.

While the above description provides examples of one or more apparatus, methods, or systems, it will be appreciated that other apparatus, methods, or systems may be within the scope of the claims as interpreted by one of skill in the art.

1. A computer-implemented method for proposal and a donation of an object, the method comprising:
receiving object information entered on a donor device, wherein the object information describes the object offered for donation;
receiving validation of the object information from an administrator device;
adding at least a subset of the object information to a catalogue, wherein the catalogue lists objects offered for donation;
transmitting the catalogue for display on a plurality of donee devices;
receiving one or more proposals to acquire the object from one or more donee devices;
receiving validation of the one or more proposals from an administrator device;
transmitting the stored proposals to the donor device at the end of the submission period; and
receiving a selection of one proposal from the donor device.

2. The method of claim 1, wherein the object information includes a plurality of terms and conditions for a prospective donee to receive the object offered for donation.

3. The method of claim 1, wherein the object information includes any one or more of: a plurality of photograph of the object, a type of the object, a subject matter of the object, a condition of the object, an acquisition detail of the object, a description of the object, a location of the object, a name of an artist who created the object, a historical background of the object, a date of creation of the object, a provenance related to the object, a dimension of the object, a type of material used in the object, a plurality of identification information of the donor, an ownership tie of the donor to the object, a third party authentication of the object, and a list of previous owners of the object.

4. The method of claim 2, wherein the plurality of terms and conditions include any one or more of: a placement condition for the donee museum, a restriction on further sale of the object, a restriction on further donation of the object, a restriction on modifying or disassembling the object, a preference to donees from a geographical location, and a plurality of rights to the object that the donor may not prefer to transfer to the prospective donee.

5. The method of claim 1, wherein validating the object information comprises:
verifying authenticity of the object;
verifying chain of title to the object; and
verifying the object information.

6. The method of claim 5, wherein validating the object information further comprises:
transmitting a request for additional object information to the donor device; and
receiving additional object information from the donor device.

7. The method of claim 1, wherein the subset of object information added to the catalogue comprises of a photograph of the object, the subject matter of the object, the description of the object, the location of the object, and the name of an artist who created the object.

8. The method of claim 1, wherein the plurality of identification information of the donor is omitted from the subset of object information.

9. The method of claim 5, wherein each proposal includes at least a name of a prospective donee, contact information of the prospective donee, the location of the prospective donee, a letter of interest, a plurality of contextual images, and shipping information.

10. The method of claim 5, wherein each proposal further includes a response by the prospective donee to the plurality of terms and conditions

11. The method of claim 9, wherein the letter of interest includes any one or more of:
details of the prospective donee, an inventory of the prospective donee, a plurality of artifacts displayed by the prospective donee, an information on appropriateness of the object in the inventory of the prospective donee, an exhibition program of the prospective donee, a historical background of the prospective donee, a plurality of collections by the artist who created the object in the inventory of the prospective donee, an account of general audience of the prospective donee, a donation policy of the prospective donee, a curatorial practice of the prospective donee, and a standard operating procedure for maintenance followed by the prospective donee.

12. The method of claim 9, wherein the plurality of contextual images by the prospective donee includes a floor plan of a donee museum, an arrangement of artworks displayed in the donee museum, a plurality of photographs of related artworks in the collection of the donee museum, a description of each contextual image, and a potential location to display the object.

13. The method of claim 1, wherein the stored proposals are transmitted to the donor device instantaneously on receiving validation from the administrator device.

14. A method for accessioning an object after selecting a proposal, the method comprising:
submit a donation form from a donor terminal over a donation management computer system for donating an object to a selected donee;
notify the selected donee on being selected as a recipient of the object set for donation and transmit a donation form information to a donee terminal; and
confirm an acceptance from the donee terminal on being selected as the recipient of the object set for donation, wherein the confirmation is based on the review of the donation form information.

15. The method of claim 14, wherein the donation form includes information on the ownership of a donor on the object set for donation, identification information of a representative of the donor, identification information on the donor, a mailing address of the donor, and a credit line of the donor.

16. The method of claim 14, wherein the confirmation of the acceptance from the donee terminal further includes:
assigning a registrar as a designated representative to respond to a plurality of formal requirements, provide documentation and a signature for the accessioning of the object.

17. The method of claim 14, further comprising concluding a Deed of Gift between the donor and the selected donee, comprising the steps of:
transmit the Deed of Gift from the donee terminal over a donation management computer system, wherein the transmission includes assigning a representative of the selected donee to countersign the Deed of Gift;
review of the Deed of Gift by the donor terminal;
provide an electronic signature to the Deed of Gift at the donor terminal, wherein the Deed of Gift includes a credit line of the donor;
provide an electronic counter-signature to the Deed of Gift at the donee terminal, wherein the representative of the selected donee is notified by the donation management computer system when the electronic signature to the Deed of Gift at the donor terminal is executed; and
wherein the Deed of Gift transfers a title and an ownership of the object from the donor to the selected donee.
